(19) United States
(12) Patent Application Publication
(10) Pub. No.: US 2013/0182547 A1
(43) Pub. Date: Jul. 18, 2013

(54) OPTICAL DISK DEVICE AND OPTICAL PICKUP THEREFOR

(71) Applicant: HITACHI MEDIA ELECTRONICS CO., LTD., Oshu-shi (JP)

(72) Inventors: Daisuke TOMITA, Yokohama-shi (JP); Jun HATO, Fujisawa-shi (JP); Kenji KIYA, Fujisawa-shi (JP); Tsukasa TAKAHASHI, Yokohama-shi (JP)

(73) Assignee: HITACHI MEDIA ELECTRONICS CO., LTD., Oshu-shi (JP)

(21) Appl. No.: 13/716,643

(22) Filed: Dec. 17, 2012

(30) Foreign Application Priority Data
Jan. 13, 2012 (JP) 2012-005191

(51) Int. Cl. G11B 7/1392

(52) U.S. Cl. CPC G11B 7/13927
USPC 369/44.23

(57) ABSTRACT

When an optical pickup used for an optical disk device is formed, the optical pickup includes a stepping motor which drives a lens used to correct for spherical aberration, and the stepping motor is mounted in such a manner that the stepping motor is exposed at a surface (upper part) where the stepping motor faces the optical disk. In addition, the stepping motor is mounted in such a manner that the stepping motor is exposed at a surface (lower part) opposite the surface where the stepping motor faces the optical disk.

Consequently, the optical pickup used for an optical disk device is adapted to cool a built-in stepping motor without using expensive components when the optical pickup is formed, the optical pickup being configured to make the optical pickup itself thinner and making the operation of the stepping motor stable.

### CLAIMS OF PRIORITY

The present application claims priority from Japanese patent application serial no. JP2012-005191, filed on Jan. 13, 2012, the content of which is hereby incorporated by reference into this application.

### BACKGROUND OF THE INVENTION

The present invention relates to an optical disk device and an optical pickup used therefor. The invention more particularly relates to an optical disk device which is mounted in a notebook-type personal computer, etc., is suitable for a thin-shaped model, stably operates an optical pickup, is inexpensive, and is manufactured with ease. The invention also relates to an optical pickup used for the optical disk device.

Conventionally, optical disk devices achieve widespread use as devices for reading and writing digital information. Examples of such optical disk devices include a CD (Compact Disk) drive unit, a DVD (Digital Versatile Disk) drive unit, and particularly a recent BD (Blu-ray Disc) drive unit.

These optical disk devices are operated as follows. An optical disk is rotated by a spindle motor built in a drive. The rotating optical disk is then irradiated with laser light from a laser diode that is a light source incorporated in an optical pickup, and the light reflected from the optical disk is read by a pickup lens and is recognized as information.

It can be said that such an optical pickup is the most important component for the optical disk device composed of a laser light source, a light receiving element and precise mechanical parts.

With the recent popularization of notebook-type personal computers, in particular, devices themselves are getting more lightweight and slimmer, and thin-shaped optical pickups are also being developed.

For example, photographs of an optical pickup for a slim BD drive are disclosed in FIG. 1 of “Slim-type BD drive having a thickness of 12.7 mm”, [online], Horinouchi, et al., Panasonic Technical Journal, Vol. 54, No. 3, October 2008 [searched on 28 Dec. 2011], Internet <URL:http://panasonic.co.jp/ptj/v5403/pdf/p0104.pdf>. In addition, JP-A-2011-165251 has disclosed a shape of an optical pickup in FIG. 2 thereof.

In particular, a BD disc is multilayered, and its optical pickup is provided with a mechanism for correcting for spherical aberration of a beam. Disclosure in 3.2 (FIG. 3) of the abovementioned paper written by Horinouchi includes a mechanism for moving a collimator lens by a stepping motor to correct for spherical aberration.

Moreover, JP-A-2009-266309 discloses an optical disk device that includes an optical pickup provided with a beam expander constituted of a moving lens and a fixed lens, the moving lens being moved by a stepping motor.

As described above, the optical pickup for the BD drive incorporates a stepping motor to drive a lens for spherical aberration correction.

This stepping motor generates a large amount of heat, for example, when access layers of the BD disc are frequently switched therebetween. In order to radiate the heat, a heat transfer agent such as heat releasing silicon is conventionally provided between the stepping motor and other members: an optical pickup housing made of metal such as aluminum and stainless steel (SUS); a metal cover; a heat sink for heat radiation; and the like, thereby dispersing the heat for heat radiation.

However, there are the following problems: the metal housing for the optical pickup, the metal cover and the heat sink for heat radiation are expensive; it is difficult to makes the optical pickup thinner since the optical pickup itself includes the stepping motor therein; and it is difficult to achieve the stable operation because the stepping motor is not be configured with a larger diameter.

The present invention has been made to solve the abovementioned problems. A primary object of the present invention is to provide an optical pickup for an optical disk device that is adapted to cool a built-in stepping motor without using expensive components when the optical pickup is formed, the optical pickup being configured to make the optical pickup itself thinner and making the operation of the stepping motor stable.

### SUMMARY OF THE INVENTION

In the optical disk device according to the present invention, an optical pickup includes a stepping motor which drives a lens used to correct for spherical aberration; and the stepping motor is mounted in such a manner that the stepping motor is exposed at a surface (upper part) where the stepping motor faces the optical disk.

In addition, the stepping motor is mounted in such a manner that the stepping motor is exposed at a surface (lower part) opposite the surface where the stepping motor faces the optical disk.

Consequently, the present invention can provide an optical pickup for an optical disk device that is adapted to cool a built-in stepping motor without using expensive components when the optical pickup is formed, the optical pickup being configured to make the optical pickup itself thinner and making the operation of the stepping motor stable.

### BRIEF DESCRIPTION OF DRAWINGS

FIG. 1 is a perspective view of the whole optical disk device according to one embodiment of the present invention;

FIG. 2 is a top view of the whole optical disk device according to one embodiment of the present invention;

FIG. 3A is a top view (1) of an optical pickup according to the conventional art;

FIG. 3B is a top view (2) of an optical pickup according to the conventional art;

FIG. 4A is a top view (1) of an optical pickup according to this embodiment;

FIG. 4B is a top view (2) of an optical pickup according to this embodiment;

FIG. 5 is a diagram illustrating optical components inside the optical pickup;

FIG. 6 is a diagram illustrating implementation of a stepping motor of an optical pickup according to the conventional art (A-A cross sectional view of FIG. 3A); and

FIG. 7 is a diagram illustrating implementation of a stepping motor of an optical pickup according to this embodiment (B-B cross sectional view of FIG. 4A).

### DESCRIPTION OF THE PREFERRED EMBODIMENT

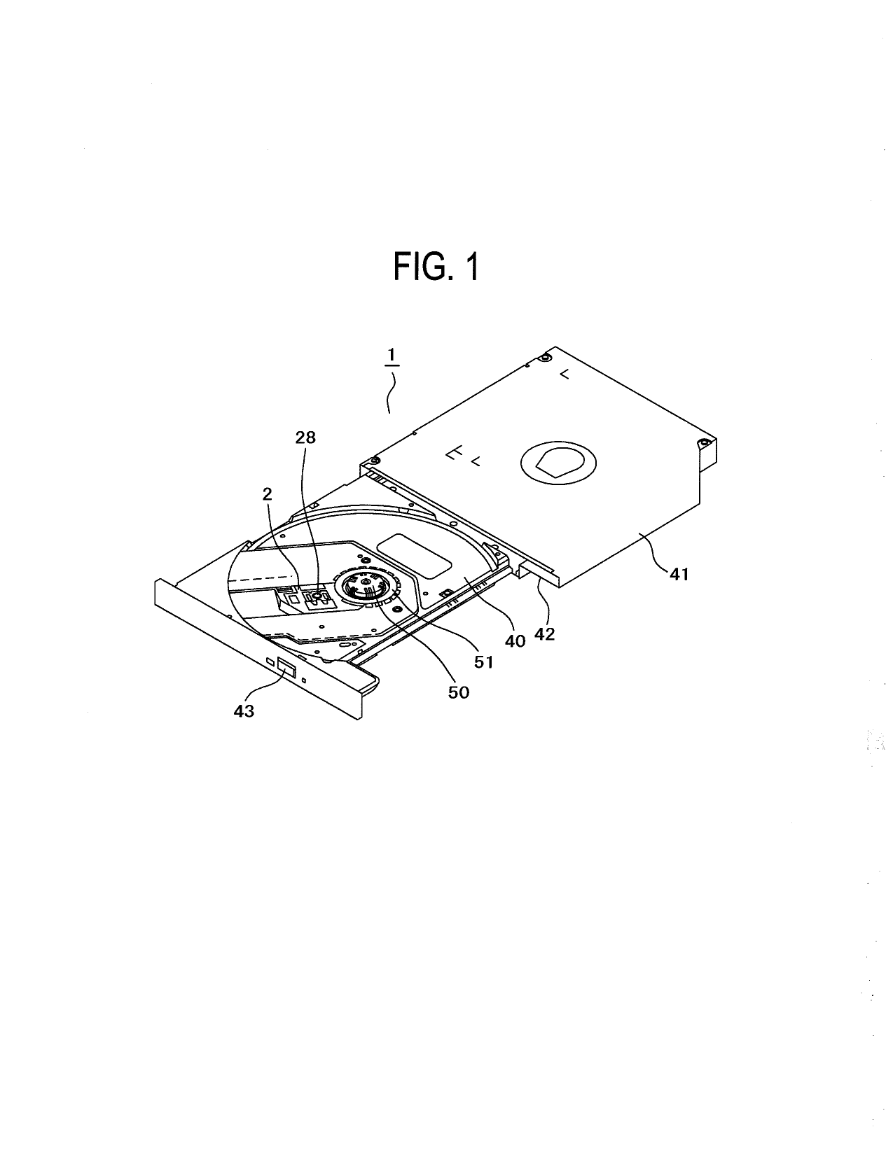

Embodiments of the present invention will be described with reference to FIG. 1 or FIG. 7 as below.

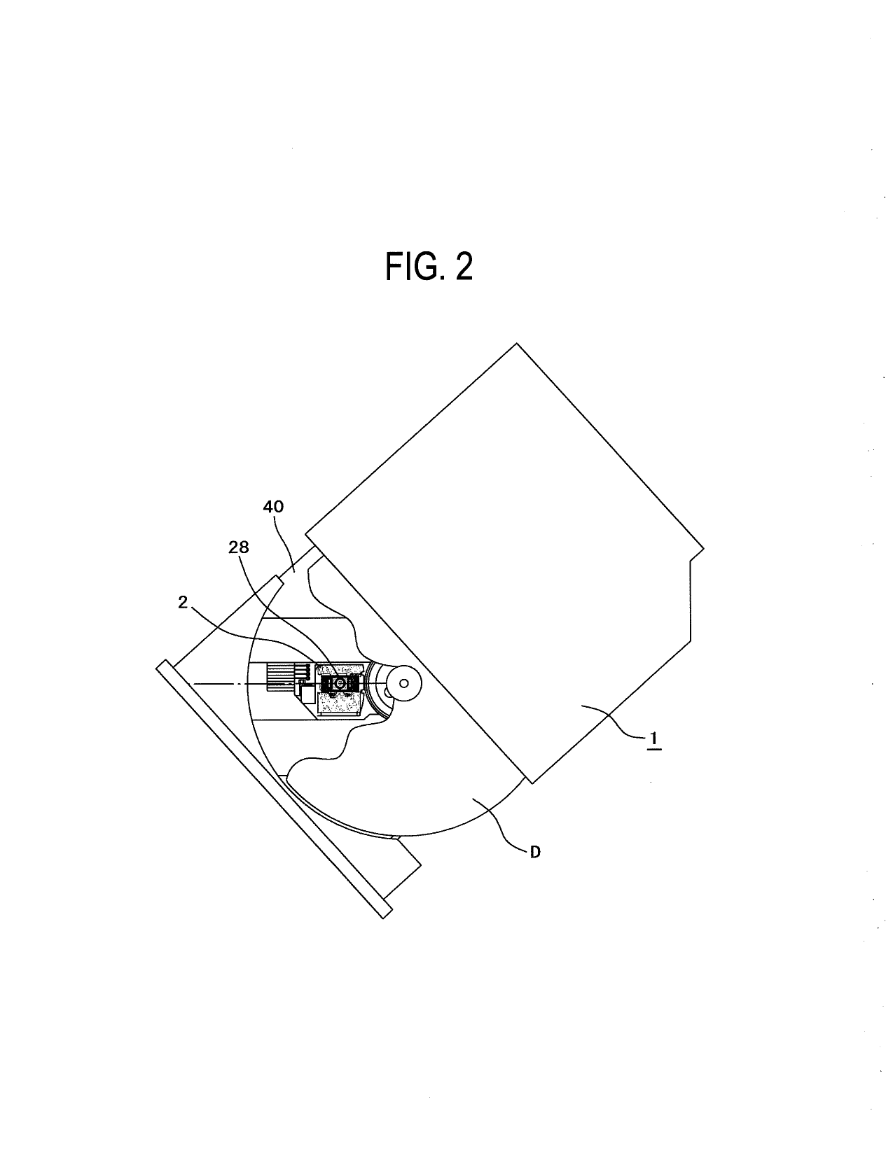

First of all, a structure of an optical disk device will be described with reference to FIGS. 1 and 2.

FIG. 1 is a perspective view of the whole optical disk device according to one embodiment of the present invention.

FIG. 2 is a top view of the whole optical disk device according to one embodiment of the present invention.

The optical disk device according to this embodiment is a thin (slim type) drive unit with which a notebook PC or the like is equipped. As shown in FIG. 1, the optical disk device has a chassis section constituted of a top chassis 41 and a bottom chassis 42 fitted therein. The optical disk device is adapted to draw out a tray 40 on which an optical disk is placed by allowing a user to press an eject button 43, or accepting an instruction for eject operation from a personal computer so that a mechanical unit is operated.

To read/write data from/to an optical disk such as CD, DVD and BD, an optical disk is fitted to a chuck 50 of a shaft portion of a turn table 51 in place and the tray 40 is then inserted into the chassis section. In this state, if the optical disk is irradiated with a laser beam from an objective lens 28 of an optical pickup 2, the optical disk device can read/write the data. The turn table is adapted to rotate by a spindle motor (not shown) during a data reading operation or a data writing operation.

FIG. 2 is a top view of the optical disk device with an optical disk D inserted. FIG. 2 also illustrates the optical pickup 2 below the optical disk D, with a portion of the optical disk D cut away, showing the optical pickup 2.

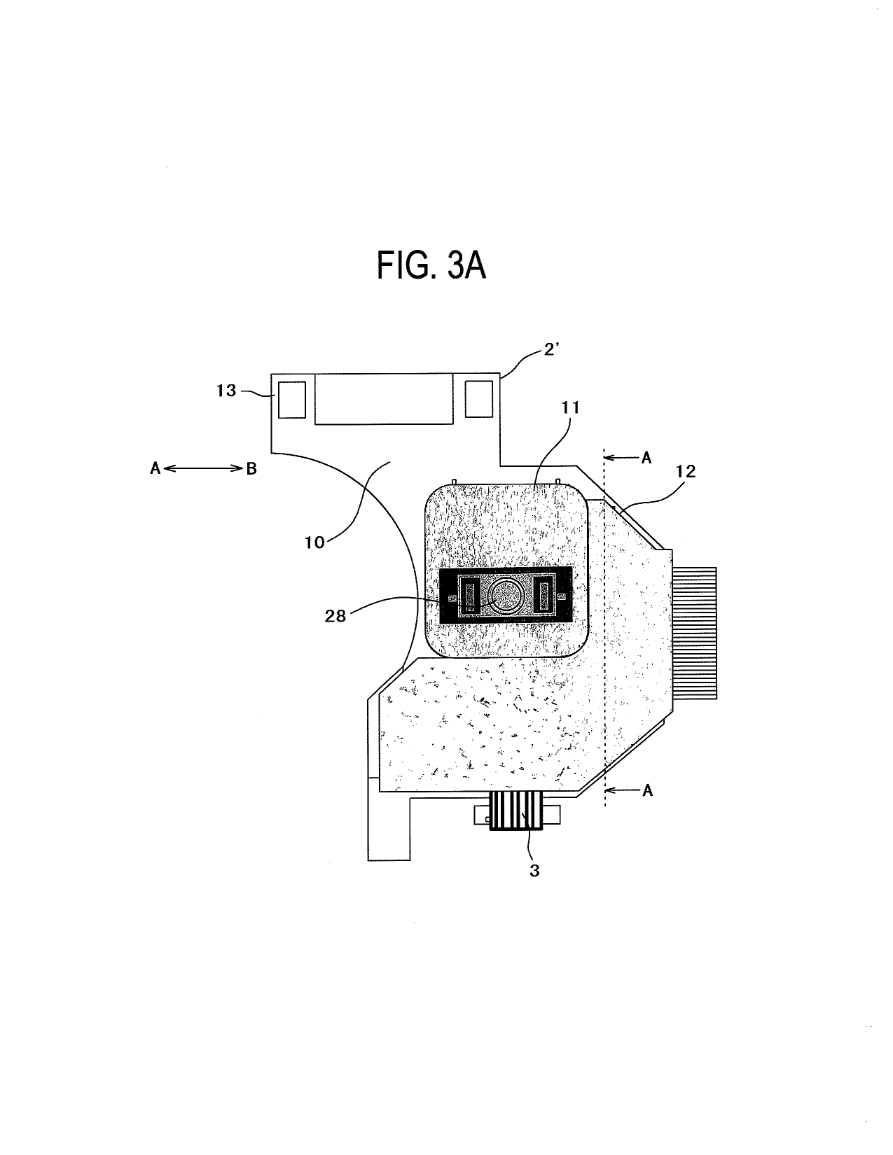

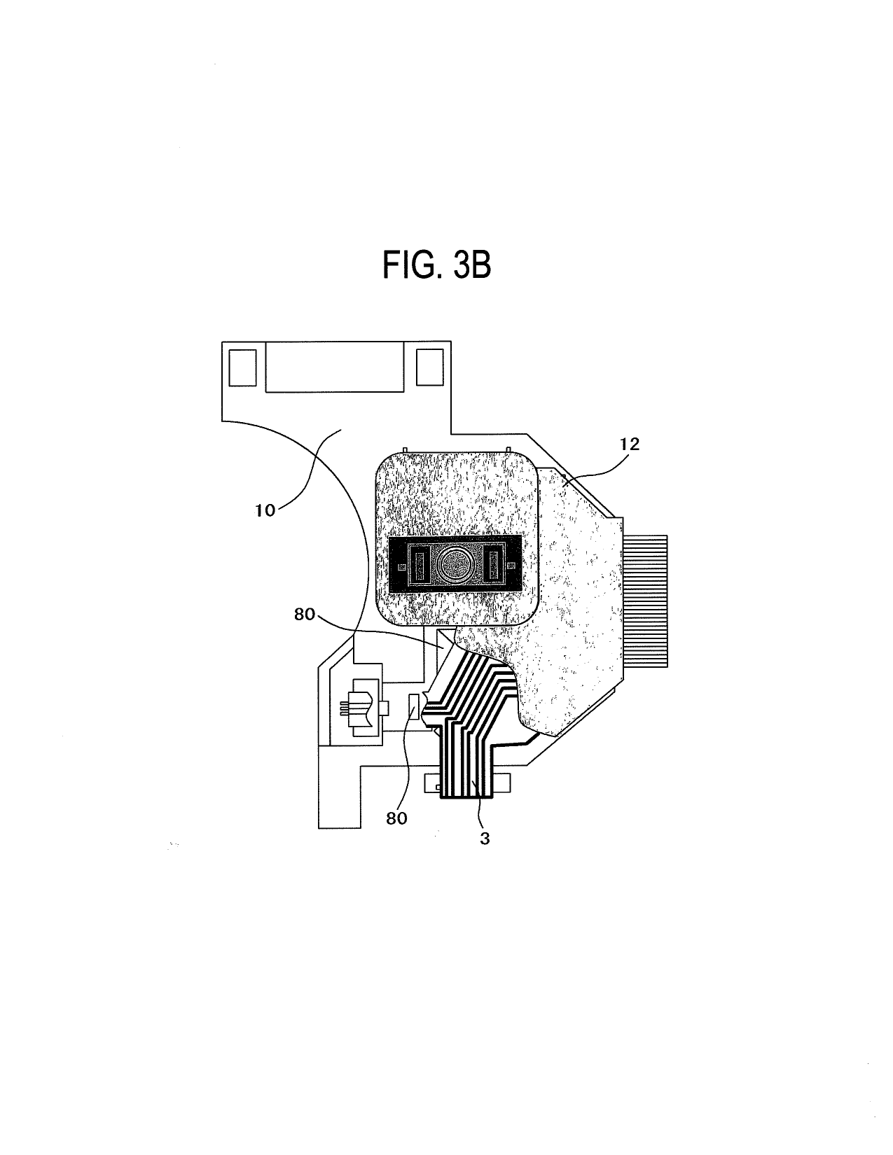

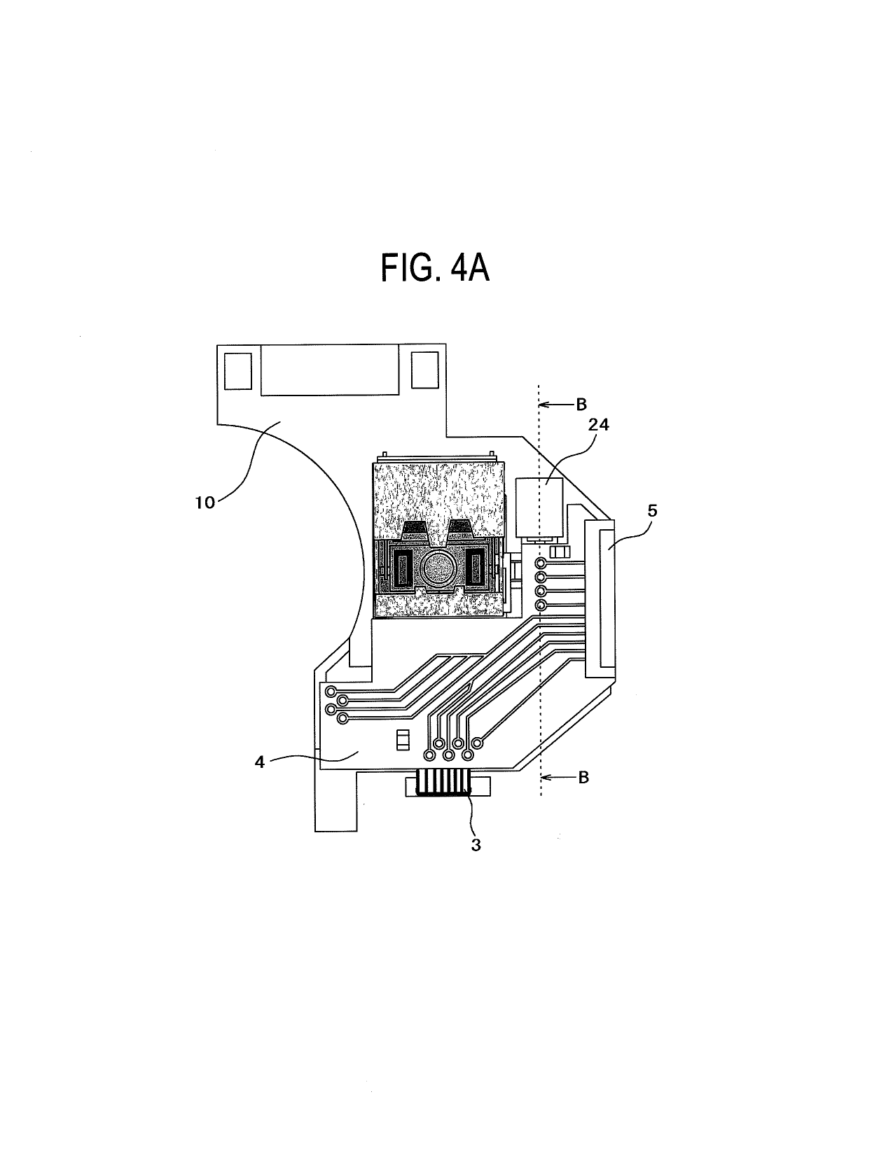

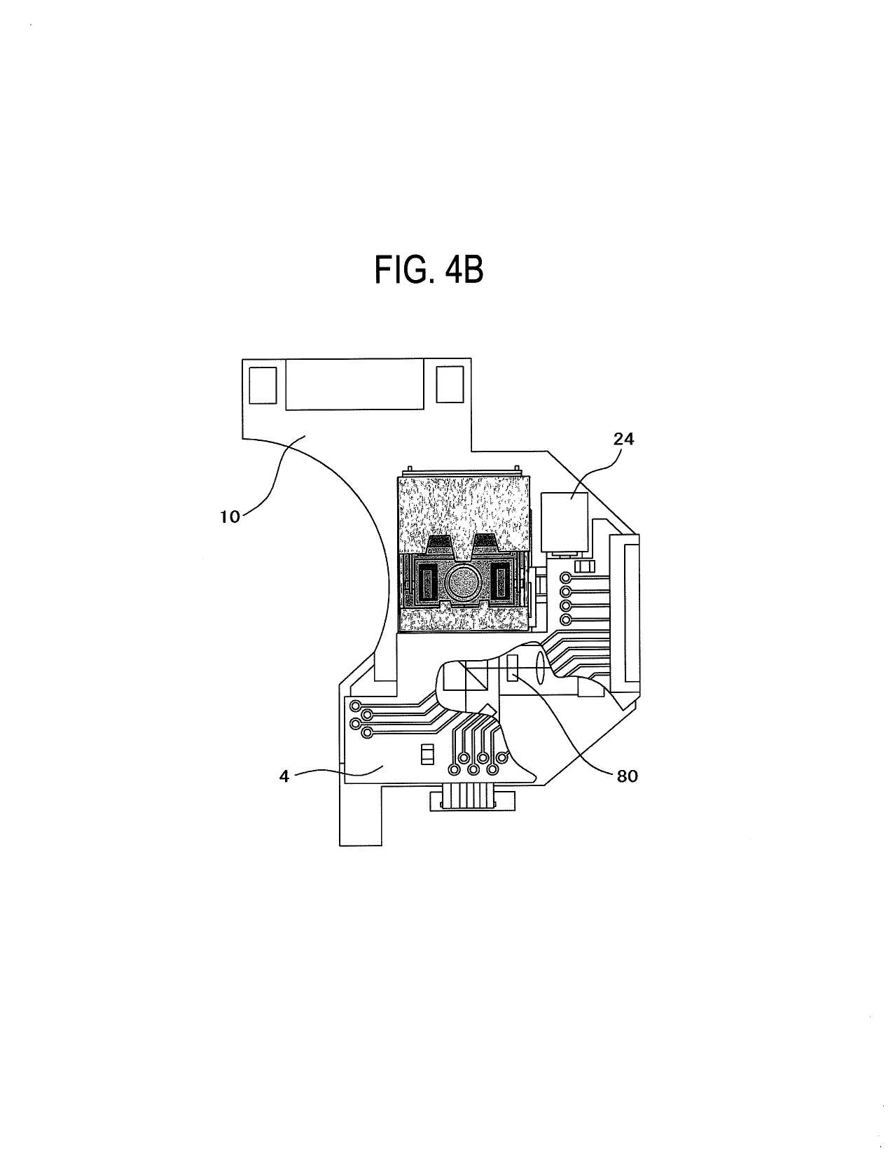

Next, the structure of the optical pickup of the optical disk device according to this embodiment will be described with reference to FIGS. 3A to 4B in contrast with the conventional art.

FIGS. 3A and 3B are top views each illustrating an optical pickup according to the conventional art.

FIGS. 4A and 4B are top views each illustrating the optical pickup according to this embodiment.

FIG. 3A illustrates an optical pickup 2′ according to the conventional art as viewed from the top (in other words, as viewed from the surface that faces the optical disk D). The optical pickup 2′ is formed with an opening 13 through which a main shaft is passed, and is adapted to move in an AB direction by a stepping motor (not illustrated) according to an access position to access the optical disk D. Here, an A-direction is the direction toward the center of rotation while a B-direction is the direction toward the outer circumference.

The optical pickup 2′ according to the conventional art has optical components 80 arranged within a pickup housing 10. The optical components inside the pickup housing 10 are sealed by a rectangular metal cover 11 disposed around a pickup lens 28, and a L-shaped metal cover 12 that comes in contact with two sides of the rectangular metal cover 11. The rectangular metal cover 11 is formed with an opening at a position corresponding to the pickup lens 28 so as to allow a laser beam to be irradiated in the direction of the optical disk D.

Here, FIG. 3B illustrates the optical components 80 with a portion of the L-shaped metal cover 12 of FIG. 3A cut away, showing the internal optical components 80.

FPC (Flexible Printed Circuits) 3 are arranged in the optical pickup 2′ to connect the internal optical components to external electric circuits. The FPC 3 has a structure in which an adhesive layer is formed on a film-like insulator (base film) having a thickness of from 12 μm to 50 μm, and a conductive foil having an approximate thickness of from 12 μm to 50 μm is further formed on the adhesive layer. Thus, the FPC 3 is a printed circuit board that is flexible and largely deformable.

Moreover, the metal cover 12 of the optical pickup 2′ according to the conventional art has not only a function of sealing the optical components 80, but also a function of holding the FPC 3 to avoid slack.

Furthermore, the optical component 80 further includes the stepping motor (not illustrated). Heat generated by the stepping motor is transferred to the metal cover 12 through a heat transfer agent, and is then radiated to the outside.

By contrast, although the electrical/optical characteristics of the optical pickup 2 according to this embodiment are the same as those of the optical pickup 2′ according to the conventional art, the implementation method is changed. Specifically, a PWB (Printed Wiring Board) 4 is used as the top cover in place of the L-shaped metal cover 12, with the PWB having a shape the same as the metal cover 12.

This PWB 4 is made by installing wiring in a plate which uses an insulating base material having no flexibility; therefore PWB 4 is also said to be a rigid board in comparison with FPC. As shown in FIG. 4B, the PWB 4 for the optical pickup 2 according to this embodiment seals the optical components 80 to prevent the immersion of foreign matters and hold the FPC 3.

Here, FIG. 4B illustrates the optical components 80 with a portion of the PWB 4 of FIG. 4A cut away, showing the internal optical components 80.

In addition, the PWB 4 is provided with a connector 5 in the outer circumferential direction of the optical disk D to allow the connection of a FPC for electrical connection to external electric circuits. Moreover, for the implementation of the optical pickup 2 by use of the PWB 4 of this embodiment, the stepping motor 24 is provided to expose thereabove; namely, an open structure is created above the stepping motor 24. The stepping motor 24 serves to operate a collimator lens to correct for drive spherical aberration when a BD disc is read. Thus, the optical pickup 2 is cooled by the air flow caused by the rotation of the optical disk D.

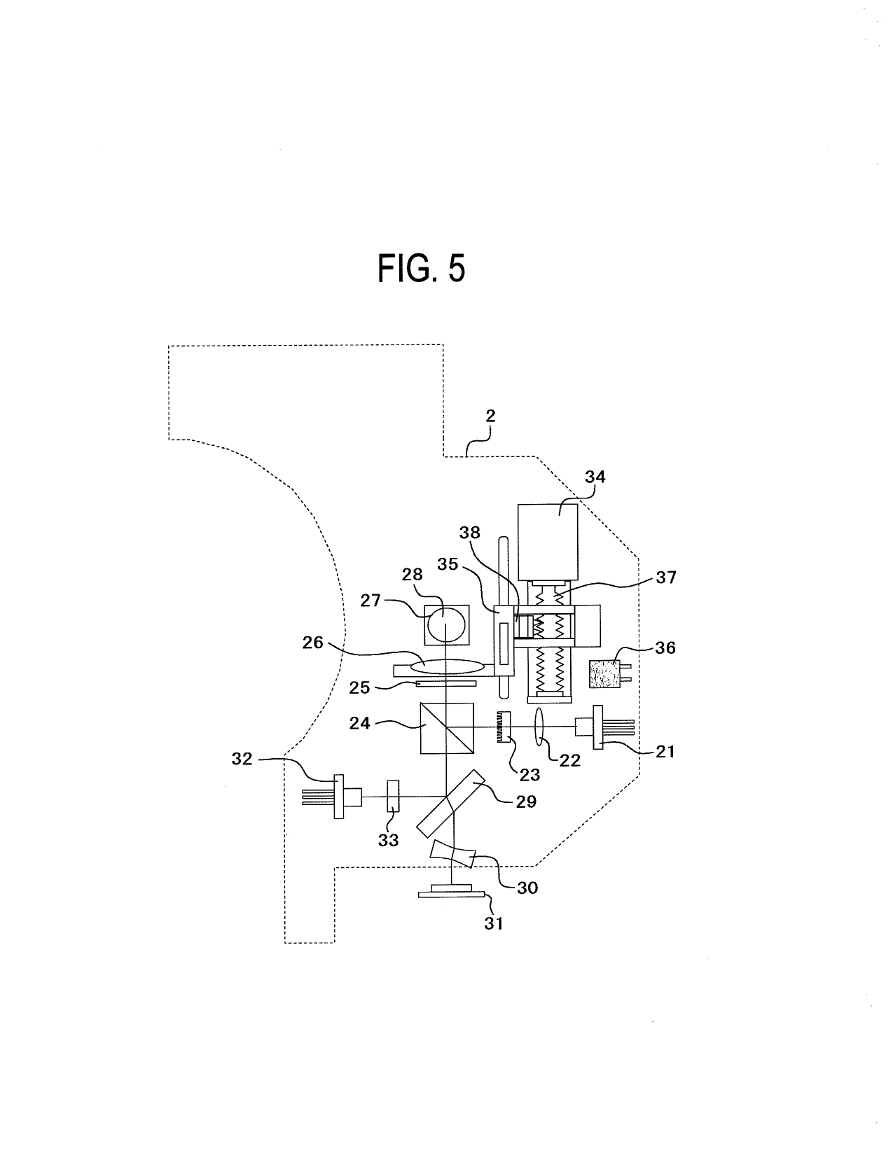

Next, an optical system inside the optical pickup will be described with reference to FIG. 5.

FIG. 5 is a diagram illustrating optical components inside the optical pickup,

First of all, an optical path in a BD system will be described.

A laser diode 21 emits a light beam of 405 nm band. The light beam of 405 nm emitted from the laser diodes 21 band transmits through an auxiliary lens 22 and a diffraction grating 23, is reflected by a prism 24, and is then introduced to a wavelength plate 25.

The wavelength plate 25 is an element that generates a predetermined phase difference. When the light beam passes through the wavelength plate, the light beam is changed in its state to become circular polarized light, which is then incident on a collimator lens 26.

The collimator lens 26 has a function of transforming an incident light beam to a parallel light beam. The light beam output from the collimator lens 26 is emitted as a parallel light beam.

In addition, the collimator lens 26 is mounted to a collimator lens holder 35 which is provided with a gear 38. By rotating a screw 37 of a stepping motor 34, the lens holder 35 allows the gear 38 to move the collimator lens 26 mounted to the collimator lens holder 35 in the optical axis direction. In this case, an optical sensor 36 is a return-to-origin optical sensor, and is used as an operation reference position. Thus, the collimator lens 26 is moved in the optical axis direction by the stepping motor 34, thereby correcting for spherical aberration caused by, for example, the difference between layers for reading of the optical disk D.

Next, the light beam output from the collimator lens 26 is reflected by a rising mirror 27, is condensed by an objective lens 28, and is then incident on the optical disk D.

The optical disk D has minute pit structure areas formed on a recording surface thereof. Through the minute pit structure areas, phase information is added to the incident light beam. The light beam to which the information has been added is reflected by the optical disk D, and returns through the objective lens 28, the rising mirror 27 and the collimator lens 26 in order through repetitive transmission and reflection. Subsequently, the light beam is then converted by the wavelength plate 25 into a light beam, the polarization of which is rotated by 90° from that of the light beam of the outgoing path, and is incident on the prism 24. The light beam, the polarization of which has been rotated by 90° by the wavelength plate 25, transmits through the prism 24, a dichroic mirror 29, and a detection lens 30, and is then introduced into a light receiving element 31.

The light receiving element 31 has a function of converting a light beam into a voltage, and converting information written to the optical disk into an electric signal. Thus, the light beam is converted into a voltage, and the information written to the optical disk is converted into an electric signal.

Next, an optical path in a DVD/CD system will be described.

A laser diode 32 emits light beams of 656 nm band and 795 nm band. The light beams of 656 nm band and 795 nm band emitted from the laser diode 32 transmit through a diffraction grating 33, are reflected by the dichroic mirror 29, and transmit through the prism 24. The polarization of the light beam transmitted through the prism 24 is then changed to circular polarized light by the wavelength plate 25. Subsequently, the light beam is transformed to a parallel light beam by the collimator lens 26. The parallel light beam is reflected by the rising mirror 27, is condensed by the objective lens 28, and is incident on the optical disk D.

As described above, the optical disk D has minute pit structure areas formed on a recording surface thereof. Through the minute pit structure areas, phase information is added to the incident light beam. The light beam to which the phase information has been added is reflected by the optical disk, and returns through the objective lens 28, the rising mirror 27 and the collimator lens 26 in order through repetitive transmission and reflection. Subsequently, the light beam is then converted by the wavelength plate 25 into a light beam, the polarization of which is rotated by 90° from that of the light beam of the outgoing path, and is incident on the prism 24.

The light beam, the polarization of which has been rotated by 90° by the wavelength plate 25, transmits through the prism 24, the dichroic mirror 29, and the detection lens 30, and is then introduced into the light receiving element 31. As described above, the light beam is converted into a voltage, and the information written to the optical disk is converted into an electric signal.

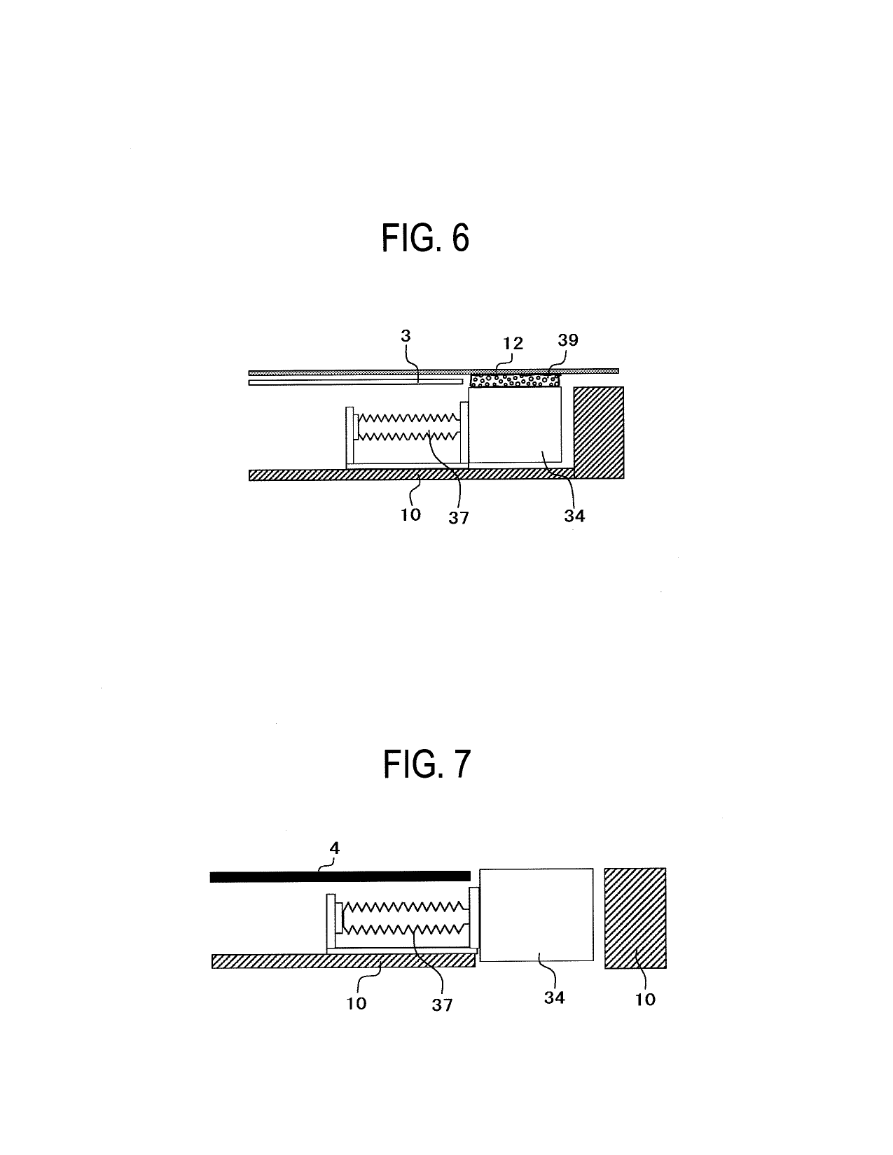

Next, implementation of the stepping motor of the optical pickup according to this embodiment will be described with reference to FIGS. 6 and 7 in contrast with the conventional art.

FIG. 6 is a diagram illustrating implementation of the stepping motor of the optical pickup according to the conventional art (A-A cross sectional view of FIG. 3A).

FIG. 7 is a diagram illustrating implementation of the stepping motor of the optical pickup according to this embodiment (B-B cross sectional view of FIG. 4A).

As shown in FIG. 6, the stepping motor 34 for the optical pickup 2′ according to the conventional art is built in a space between the metal cover 12 and the optical pickup housing 10. Heat releasing silicon 39 which serves as a heat transfer agent is provided between the metal cover 12 and the stepping motor 34.

By contrast, as shown in FIG. 7, the stepping motor 34 for the optical pickup 2 according to this embodiment is disposed under open-structure environment which is open on the upper and lower sides, i.e., the stepping motor 34 is exposed from the PWB 4 and the optical pickup housing 10. In particular, it is expected that the air flow caused by the rotation of the optical disk D will efficiently cool the stepping motor 34 on the upper side.

Moreover, in comparison with the case of the conventional art shown in FIG. 6, the stepping motor 34 has a value of a diameter substantially the same as that of thickness of the optical pickup 2, and therefore great slimming can be achieved. Consequently, since the stepping motor 34 has a larger diameter, it can stably operate with high output.

Incidentally, the optical pickup for the slim-type optical disk device is taken as an example in this embodiment. However, the present invention is not limited to this. The present invention can also be applied to an optical pickup of the other type of optical disk device such as a half-height type optical disk device.

What is claimed is:

1. An optical disk device which reads/writes information by rotating an optical disk and irradiating the optical disk with a laser beam from an optical pickup, wherein,
the optical pickup includes a stepping motor which drives a lens used to correct for spherical aberration; and
the stepping motor is mounted in such a manner that the stepping motor is exposed at a surface where the stepping motor faces the optical disk.

2. The optical disk device according to claim 1, wherein:
the stepping motor is mounted in such a manner that the stepping motor is exposed at a surface opposite the surface where the stepping motor faces the optical disk.

3. The optical disk device according to claim 1, wherein:
a printed wiring board which serves as a top cover is used at least a part of a surface of a housing which houses the optical pickup, the surface facing the optical disk; and
a component disposed in the optical pickup is sealed by the printed wiring board.

4. An optical pickup for an optical disk device that reads/writes information by rotating an optical disk and irradiating the optical disk with a laser beam from the optical pickup, wherein,
the optical pickup includes a stepping motor which drives a lens used to correct for spherical aberration; and
the stepping motor is mounted in such a manner that the stepping motor is exposed at a surface where the stepping motor faces the optical disk.

5. The optical pickup according to claim 4, wherein:
the stepping motor is mounted in such a manner that the stepping motor is exposed at a surface opposite the surface where the stepping motor faces the optical disk.

6. The optical pickup according to claim 4, wherein:
a printed wiring board which serves as a top cover is used at least a part of a surface of a housing which houses the optical pickup, the surface facing the optical disk; and
a component disposed in the optical pickup is sealed by the printed wiring board.
